(19) United States
(12) Patent Application Publication
(10) Pub. No.: US 2012/0049794 A1
(43) Pub. Date: Mar. 1, 2012

(54) INTEGRATED CHARGING DEVICE FOR ELECTRIC VEHICLE

(75) Inventors: Kyu Bum Han, Gyunggi-do (KR); Joon Seok Chae, Gyunggi-do (KR); Man Suk Seo, Gyunggi-do (KR)

(73) Assignee: SAMSUNG ELECTRO-MECHANICS CO., LTD., Gyunggi-do (KR)

(21) Appl. No.: 12/965,478

(22) Filed: Dec. 10, 2010

(30) Foreign Application Priority Data
Aug. 30, 2010 (KR) 1020100084225

(51) Int. Cl. H02J 7/00

(52) U.S. Cl. 320/109

(57) ABSTRACT

Disclosed herein is an integrated charging module device for an electric vehicle. The integrated charging module device for an electric device includes: a main battery supplying power for driving an electric vehicle; an auxiliary battery supplying power for driving an auxiliary device within the electric vehicle; an integrated charging module converting external power into a first DC voltage to be charged in the main battery and a second DC voltage to be charged in the auxiliary battery; and a control module controlling the charging of the main battery and the auxiliary battery. The present invention includes the integrated charging modules for charging the main battery and the secondary battery, thereby making it possible to increase the efficiency of the spatial arrangement in a vehicle and simplifying the cooling system.

### CROSS REFERENCE TO RELATED APPLICATION

This application claims the benefit of Korean Patent Application No. 10-2010-0084225, filed on Aug. 30, 2010, entitled “Integrated Charging Device For Electric Vehicle,” which is hereby incorporated by reference in its entirety into this application.

### BACKGROUND OF THE INVENTION

1. Technical Field

The present invention relates to an integrated charging device for an electric vehicle.

2. Description of the Related Art

Generally, an electric vehicle (EV) includes a secondary battery (main battery) for a power supply for driving a vehicle used as a driving source of a driving motor for driving a vehicle. The secondary battery (main battery) for a power supply for driving a vehicle is an on-board charger that is mounted in the vehicle to receive AC power from an external household power supply, converts the AC power into DC power required to charge a battery, and charges the DC power.

In addition, the electric vehicle includes a separate secondary battery (auxiliary battery) for an auxiliary power supply in addition to a secondary battery (main battery) for a power supply for driving a vehicle and the secondary battery (auxiliary battery) for the auxiliary power supply is used as a driving source for driving a radio, an audio, and a window, etc., in the vehicle.

The charger for the electric vehicle according to a prior art receives AC power from the external power supply, converts the AC power into DC power suitable to charge the battery, and charges the DC power in the secondary battery (main battery) for the battery, and charges the DC power in the secondary battery (main battery) for the power supply for driving the vehicle. Thereafter, the charger for the electric vehicle receives the DC power from the secondary battery (main battery) for the power supply for driving the vehicle and converts the DC power into DC power suitable for the secondary battery (auxiliary battery) for the auxiliary power supply by a low voltage current converter.

However, the charger for the electric vehicle according to a prior art occupies a large space in the vehicle since the secondary battery (main battery) for the power supply for driving the vehicle and the secondary battery (auxiliary battery) for the auxiliary power supply are each provided as a separate module.

In addition, the structure of the entire system is complicated and the weight thereof is increased since a separate cooling system for each module is needed, such that the installation cost and the maintenance cost are increased.

### SUMMARY OF THE INVENTION

The present has been made in an effort to provide an integrated charging device for an electric vehicle by integrating charging modules for charging a secondary battery (main battery) for a power supply for driving a vehicle and a secondary battery (auxiliary battery) for an auxiliary power supply.

An integrated charging device for an electric vehicle according to a preferred embodiment of the present invention includes: a main battery supplying power for driving an electric vehicle; an auxiliary battery supplying power for driving an auxiliary device within the electric vehicle; an integrated charging module converting external power into a first DC voltage to be charged in the main battery and a second DC voltage to be charged in the auxiliary battery; and a control module controlling the charging of the main battery and the auxiliary battery.

The integrated charging device may further include a battery management system mounted in the main battery and monitoring the state of the main battery to control the charging of the main battery.

The integrated charging module may include: an input filter removing high frequency noise of the AC power input from the external power supply; a rectifier rectifying the AC power from which the noise is removed and converting it into the DC power; a power factor correction circuit correcting power factor of the converted DC power; a large-capacity capacitor smoothing the DC power of which power factor is corrected; a DC/DC converter for a main battery converting the smoothed DC power into the boosted or reduced first DC voltage to be charged in the main battery; and a DC/DC converter for an auxiliary battery converting the smoothed DC power into the boosted or reduced second DC voltage to be charged in the auxiliary battery.

The integrated charging module may further include: a first output filter removing noise of the DC power output from the DC/DC converter for the main battery; and a second output filter removing noise of the DC power output from the DC/DC converter for the auxiliary battery.

The DC/DC converter for the main battery may be a high voltage DC converter.

The DC/DC converter for the auxiliary battery may be a low voltage DC converter The DC/DC converter for the main battery may include: a first switching bridge converting the smoothed DC power into the AC power; a first transformer boosting or reducing the converted AC power according to the capacity of the main battery; and a first rectifying circuit converting the transformed AC power into the DC power to be charged in the main battery.

The DC/DC converter for the auxiliary battery may include: a second switching bridge converting the smoothed DC power into the AC power; a second transformer boosting or reducing the converted AC power according to the capacity of the auxiliary battery; and a second rectifying circuit converting the transformed AC power into the DC power to be charged in the auxiliary battery.

The control module may control the amount of power output from the converted AC power to allow the first transformer to boost or reduce the converted AC power according to the capacity of the main battery.

The control module may control the output power amount of the converted AC power to allow the second transformer to boost or reduce the converted AC power according to the capacity of the auxiliary battery.

### BRIEF DESCRIPTION OF THE DRAWINGS

FIG. 1 is a schematic functional block diagram of an integrated charging device for an electric vehicle according to a preferred embodiment of the present invention; and

FIG. 2 is a detailed block diagram showing an integrated charging module of the integrated charging device for the electric vehicle shown in FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

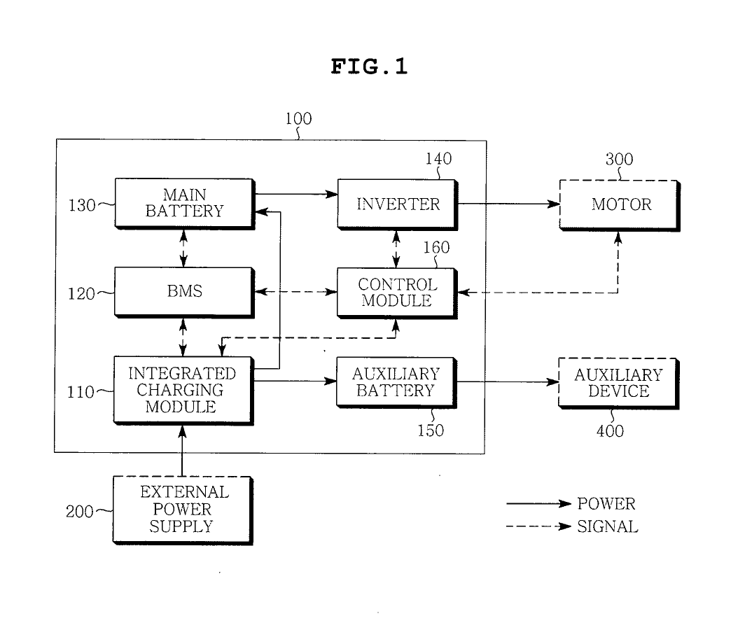

FIG. 1 is a schematic functional block diagram of an integrated charging device for an electric vehicle according to a preferred embodiment of the present invention.

Referring to FIG. 1, an integrated charging device 100 for an electric vehicle according to a preferred embodiment of the present invention is configured to include an integrated charging module 110, a battery management system (BMS) 120, a main battery 130, an inverter 140, an auxiliary battery 150, and a control module 160. The integrated charging module 110 receives AC power from an external power supply 200 and converts the AC power into DC power suitable to charge a battery.

In this case, the converted DC power is branched into the main battery 130 and the auxiliary battery 150, respectively, and is converted into power suitable to charge the corresponding battery.

The battery management system (BMS) 120 is mounted in the main battery 130 monitors the state of the main battery 130 (for example, voltage, current, temperature, etc.) to calculate the charging state and controls whether or not the main battery 130 is charged according to the calculated charging state.

The main battery 130 is a secondary battery for supplying a driving source to a motor 300 for driving the electric vehicle according to the present invention. For example, a Li-based, a Ni-based battery, or the like, are used.

As described above, the main battery 130 communicates with the BMS 120 to be charged or discharged according to the state of the main battery 130.

The inverter 140 converts the DC power supplied from the main battery 130 into the AC power and supplies the AC power to the motor 300, in order to drive the motor 300. The motor 300 is a motor for driving a wheel and receives a driving source from the AC power supply supplied from the inverter 140 to be driven at a driving speed controlled from a control module 160.

The auxiliary battery 150 is a secondary battery for an auxiliary power supply to drive an auxiliary device 400 requiring the DC power supply in the electric vehicle, in addition to the power supply for driving the vehicle.

As the auxiliary device 400 in the electric vehicle, there may be, for example, electronic devices, such as a radio, an audio, a window, or the like.

The control module 160 generally controls the integrated charging device 100 for the electric vehicle according to the present invention.

In detail, the control module 160 performs a control to convert AC power received from the external power supply 200 into DC power supply by the integrated charging module 110 and then, branch and supply the converted DC power into the main battery 130 and the auxiliary battery 150, respectively.

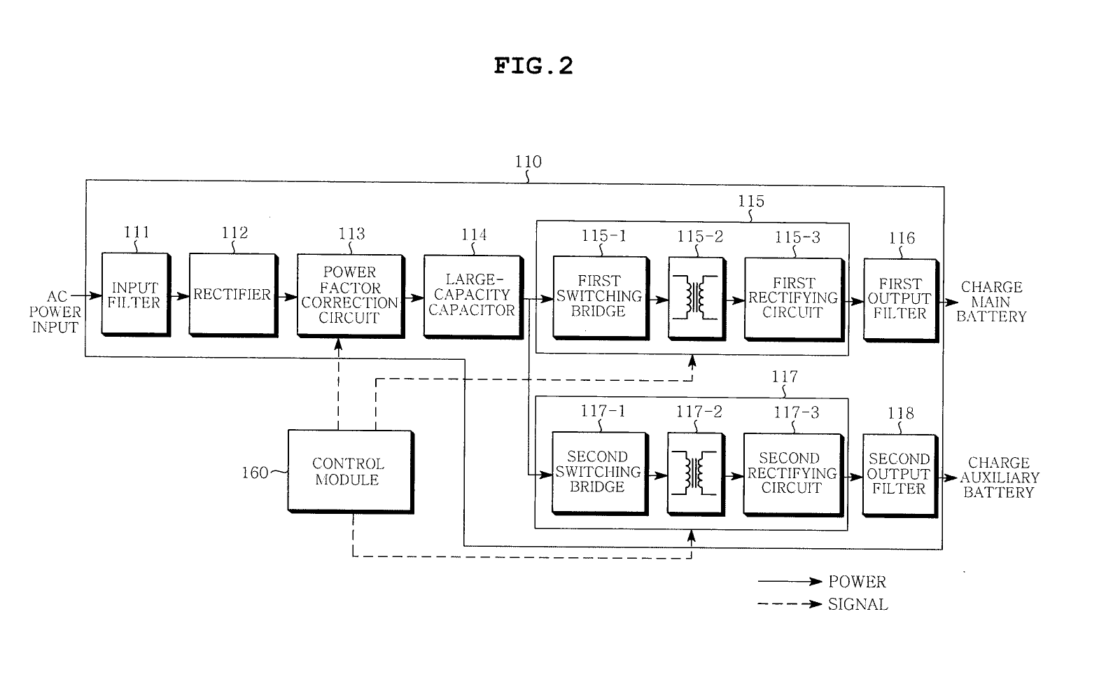

FIG. 2 is a detailed block diagram showing an integrated charging module of the integrated charging device for the electric vehicle shown in FIG. 1. Referring to FIG. 2, the integrated charging module 110 is configured to include an input filter 111, a rectifier 112, a power factor correction circuit 113, a large-capacity capacitor 114, a DC/DC converter for a main battery 115, a first output filter 116, a DC/DC converter for an auxiliary battery 117, and a second output filter 118.

The input filter 111 removes high frequency noise of the AC power supply input from the external power supply 200 to prevent components in the integrated charging module 110 from being damaged and protects the external devices.

The rectifier 112 rectifies the AC power from which noise is removed and converts the AC power into the DC power, which is in turn supplied to the power factor the AC power into the DC power, which is in turn supplied to the power factor correction circuit 113.

The power factor correction (PFC) circuit 113 changes reactive power of the converted DC power supply into active power, thereby correcting and improving the power factor. The power factor correction contributes to the reduction in high frequency noise and the stabilization of devices.

The large-capacity capacitor 114 completely converts a pulsating current into DC current during a process of converting the AC power into the DC power and smoothes it.

As the large-capacity capacitor 114, a DC link capacitor is, for example, used.

As described above, the smoothed DC power is distributed into power for charging the main battery 130 and power for charging the auxiliary battery 150, respectively. The power distributed into each battery is converted to charge the DC power having a type suitable for each battery by the DC/DC converter 115 for the main battery and the DC/DC converter 117 for the auxiliary battery, respectively.

In detail, as shown in FIG. 2, the DC/DC converter 115 for the main battery is configured to include a first switching bridge 115-1, a first transformer 115-2, and a first rectifying circuit 115-3 and the DC/DC converter 117 for the auxiliary battery is also configured to include a second switching bridge 117-1, a second transformer 117-2, and a second rectifying circuit 117-3, similar to the DC/DC converter 115 for the main battery.

The first and second switching bridges 115-1 and 117-1 each convert the DC power smoothed by the large-capacity capacitor 114 into the AC power having a type suitable for the corresponding battery in order to charge the DC power in the main battery 130 and the auxiliary battery 150.

The converted AC power is each supplied to the first transformer 115-2 and the second transformer 117-2.

The first transformer 115-2 boosts or reduces the converted AC power to a magnitude suitable to be charged in the main battery 130 and the second transformer 117-2 boosts and reduces the converted AC power to a magnitude suitable to charge the boosts and reduces the converted AC power to a magnitude suitable to charge the converted AC power in the auxiliary battery 150.

Thereafter, the boosted or reduced AC power is each converted into the DC power through the first rectifying circuit 115-3 and the second rectifying circuit 117-3 to be charged in the main battery 130 and the auxiliary battery 150.

The noise of the converted DC power is each removed through the first output filter 116 and the second output filter 118 and then, the converted DC power is supplied to the main battery 130 and the auxiliary battery 150, respectively.

In this case, the DC/DC converter 115 for the main battery and the DC/DC converter 117 for the auxiliary battery are similar in components and operations but are different in the converted power amount.

That is, the AC power boosted or reduced through the first transformer 115-2 of the DC/DC converter 115 for the main battery is larger than the boosted or reduced AC power through the second transformer 117-2 of the DC/DC converter 117 for the auxiliary. For example, as the DC/DC converter 115 for the main battery, the high voltage DC converter having the output of 110V to 220V is generally used and as the DC/DC converter 117 for the auxiliary battery, the low voltage DC converter having the output of 24V to 48V is generally used.

In this case, the control module 160 controls the power factor correction circuit 113 to correct the power factor and controls the DC/DC converter 115 for the main battery and the DC/DC converter 117 for the auxiliary battery to control the output power to be charged in the main battery 130 and the auxiliary battery 150.

In particular, the control module 160 controls the output power amount of the converted AC power so that the first transformer 115-2 boosts or reduces the converted AC power according to the capacity of the main battery 130.

Similarly, the control module 160 controls the output power amount of the converted AC power so that the second transformer 117-2 boosts or reduces the converted AC power according to the capacity of the auxiliary battery 150. AC power according to the capacity of the auxiliary battery 150.

As described above, the integrated charging device 100 for the electric vehicle according to the preferred embodiment of the present invention integrates the charging modules for charging the main battery 130 and the auxiliary battery 150 through the above-mentioned integrated charging module 110, thereby increasing the efficiency of the spatial arrangement within the vehicle.

Further, the present invention does not have a separate cooling system for each module, thereby simplifying the system configuration including the cooling system and saving installation cost and maintenance cost of the system.

The present invention integrates the charging modules for charging the secondary battery (main battery) for the power supply for driving the vehicle and the secondary battery (auxiliary battery) for the auxiliary power supply, thereby making it possible to increase the efficiency of the spatial arrangement in a vehicle.

Further, the present invention does not have the separate cooling system for each module, thereby simplifying the system configuration including the cooling system and saving the installation cost and the maintenance cost.

Although the preferred embodiments of the present invention have been disclosed for illustrative purposes, they are for specifically explaining the present invention and thus the integrated charging device for electric vehicle according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An integrated charging device for an electric vehicle, comprising:
a main battery supplying power for driving an electric vehicle;
an auxiliary battery supplying power for driving an auxiliary device within the electric vehicle;
an integrated charging module converting external power into a first DC voltage to be charged in the main battery and a second DC voltage to be charged in the auxiliary battery; and
a control module controlling the charging of the main battery and the auxiliary battery.

2. The integrated charging device as set forth in claim 1, further comprising a battery management system mounted in the main battery and monitoring the state of the main battery to control the charging of the main battery.

3. The integrated charging device as set forth in claim 1, wherein the integrated charging module includes:
an input filter removing high frequency noise of the AC power input from the external power supply;
a rectifier rectifying the AC power from which the noise is removed and converting it into the DC power;
a power factor correction circuit correcting power factor of the converted DC power;
a large-capacity capacitor smoothing the DC power of which power factor is corrected;
a DC/DC converter for a main battery converting the smoothed DC power into the boosted or reduced first DC voltage to be charged in the main battery; and boosted or reduced first DC voltage to be charged in the main battery; and
a DC/DC converter for an auxiliary battery converting the smoothed DC power into the boosted or reduced second DC voltage to be charged in the auxiliary battery.

4. The integrated charging device as set forth in claim 3, wherein the integrated charging module further includes:
a first output filter removing noise of the DC power output from the DC/DC converter for the main battery; and
a second output filter removing noise of the DC power output from the DC/DC converter for the auxiliary battery.

5. The integrated charging device as set forth in claim 3, wherein the DC/DC converter for the main battery is a high voltage DC converter.

6. The integrated charging device as set forth in claim 3, wherein the DC/DC converter for the auxiliary battery is a low voltage DC converter.

7. The integrated charging device as set forth in claim 3, wherein the DC/DC converter for the main battery includes:
a first switching bridge converting the smoothed DC power into the AC power;
a first transformer boosting or reducing the converted AC power according to the capacity of the main battery; and
a first rectifying circuit converting the transformed AC power into the DC power to be charged in the main battery.

8. The integrated charging device as set forth in claim 3, wherein the DC/DC converter for the auxiliary battery includes:
a second switching bridge converting the smoothed DC power into the AC power;
a second transformer boosting or reducing the converted AC power according to the capacity of the auxiliary battery; and
a second rectifying circuit converting the transformed AC power into the DC power to be charged in the auxiliary battery.

9. The integrated charging device as set forth in claim 7, wherein the control module controls the amount of power output from the converted AC power to allow the first transformer to boost or reduce the converted AC power according to the capacity of to the main battery.

10. The integrated charging device as set forth in claim 8, wherein the control module controls the amount of power output from the converted AC power to allow the second transformer to boost or reduce the converted AC power according to the capacity of the auxiliary battery.
